(19) United States
(12) Patent Application Publication
(10) Pub. No.: US 2002/0101927 A1
(43) Pub. Date: Aug. 1, 2002

(54) Motion vector detecting device and motion vector detecting method

(75) Inventors: Atsuo Hanami, Tokyo (JP); Kazuya Ishihara, Tokyo (JP)

Correspondence Address: MCDERMOTT, WILL & EMERY, 600 13th Street, N.W., WASHINGTON, DC, 20005-3096, US

(73) Assignee: MITSUBISHI DENKI KABUSHIKI KAISHA

(21) Appl. No.: 09/987,269

(22) Filed: Nov. 14, 2001

(30) Foreign Application Priority Data
Feb. 1, 2001 (JP) P2001-025159

(51) Int. Cl. H04N 7/12

(52) U.S. Cl. 375/240.16; 375/240.24

(57) ABSTRACT

A motion vector detecting device and a motion vector detecting method are provided which can efficiently detect the motion vector even when the chrominance information is dominant in the image. When a mode signal (SM) indicates a chrominance signal mode, an input unit (2) outputs, to an operational unit (1), template block data and search window data in which n pieces of chrominance pixel data (Cb) and n pieces of chrominance pixel data (Cr) alternate with each other. On the basis of the data obtained from the input unit (2), the operational unit (1) calculates three evaluation values (ESa, ESo, ESe) about displacement vectors corresponding to one template block. When the mode signal (SM) indicates the chrominance signal mode, a comparator unit (3) checks the three evaluation values, and when the displacement vector has an odd horizontal vector, it judges that the three evaluation values corresponding to that displaced block are invalid, and it generates three motion vectors (MVa, MVe, MVo) on the basis of the three evaluation values judged to be valid corresponding to displacement vectors.

### BACKGROUND OF THE INVENTION

1. Field of the Invention

The present invention relates to a motion vector detecting device and a motion vector detecting method that are used in a digital moving picture compression system.

2. Description of the Background Art

Since a signal representing an image, i.e. a video signal, contains an enormous amount of data, transmitting or storing the video signal inevitably requires image compression techniques for reducing the amount of the video signal data. Generally, due to the correlation between adjacent pixels and the human perception, the video signal contains a considerable amount of redundancy. The image compression techniques for reducing the redundancy so as to reduce the amount of data are called high-efficiency coding. In this specification, in order to avoid complexity of description, the video signal representing images and the images themselves may both be referred to as “image” as long as it does not produce confusion.

The high-efficiency coding techniques include the known interframe predictive coding. In the interframe predictive coding, first, the prediction error, or the difference between pixel values, is calculated for each pixel position between the current image (frame or field) to be encoded and the reference image (frame or field) preceding or following the current image in time. The calculated prediction error is used during subsequent coding process.

For images with less motion, where the frames (or fields) are closely correlated, this method offers very efficient coding. For images with a lot of motion, however, the frames are loosely correlated and therefore the error may be so large as to rather increase the amount of transmitted or stored data.

The motion compensated interframe predictive coding is known as a technique which solves this problem. In this technique, prior to the calculation of the prediction error, the pixel values are compared between the current image and the reference image to calculate a motion vector. The motion vector is a vector which represents the magnitude and direction of the motion of a partial image between frames.

The partial image is shifted in the reference image on the basis of the calculated motion vector and used as the prediction image in the prediction error calculation. That is to say, the prediction error is calculated between the current image and the prediction image obtained by applying motion compensation to the reference image. The calculated prediction error is used in the coding process. The motion vector, too, is transmitted or stored as the compressed video signal, together with the coded signal corresponding to the prediction error.

In this way, the motion compensated interframe prediction coding performs the predictive coding between frames by taking advantage of the motion compensation using the motion vector, so that it offers high image compression efficiency even when the images contain a lot of motion.

However, the conventional motion vector detecting system adopted in the motion compensated interframe predictive coding uses only the luminance information in the video signal, so that it cannot efficiently detect the motion when the chrominance (color difference) information is dominant in the images. The luminance information and the chrominance information are disclosed in Latest MPEG Textbook, ASCII Corporation Publishing Department, pp125-128, for example.

### SUMMARY OF THE INVENTION

According to a first aspect of the present invention, a motion vector detecting device comprises: a data providing portion for providing template block data which defines pixel data in a template block and search window data which defines pixel data in a search window sized to contain the template block, the data providing portion serving such that chrominance pixel data is contained in the template block data and the search window data according to a predetermined rule in a chrominance signal containing mode; an operational portion for calculating an evaluation value by performing a predetermined inter-pixel calculation between corresponding pieces of pixel data in the template block data and search window block data which is data in a search window block as a part of the search window, each time the search window block data is varied by using the search window data so that a displacement vector which shows a change in position of the template block from an initial position in the search window is varied; and a comparator portion for performing a comparison between the evaluation values corresponding to the displacement vectors and detecting a motion vector on the basis of the result of the comparison.

Preferably, according to a second aspect, the motion vector detecting device further comprises a control portion for outputting a mode signal to the input portion, the mode signal indicating whether the mode is the chrominance signal containing mode.

Preferably, according to a third aspect, in the motion vector detecting device, the chrominance signal containing mode includes a chrominance signal mode, the data providing portion includes a data providing portion serving such that only the chrominance pixel data is contained in the template block data and the search window data according to the predetermined rule in the chrominance signal mode, the chrominance pixel data including first chrominance pixel data and second chrominance pixel data, the control portion outputs the mode signal also to the comparator portion, and the comparator portion includes a comparator portion judging whether the evaluation values are valid or invalid on the basis of whether the chrominance pixel data types agree or disagree between the corresponding pieces of pixel data in the template block data and the search window block data on the basis of the displacement vectors in the chrominance signal mode, to perform the comparison between the evaluation values judged to be valid corresponding to the displacement vectors.

Preferably, according to a fourth aspect, in the motion vector detecting device, the chrominance signal containing mode includes a luminance and chrominance mix mode, the data providing portion includes a data providing portion serving such that the luminance pixel data and the chrominance pixel data are contained in the template block data and the search window data according to the predetermined rule in the luminance and chrominance mix mode, the control portion outputs the mode signal also to the comparator portion, and the comparator portion includes a comparator portion judging whether the evaluation values are valid or invalid on the basis of whether the pixel data types agree or disagree between the corresponding pieces of pixel data in the template block data and the search window block data on the basis of the displacement vectors in the luminance and chrominance mix mode, to perform the comparison between the evaluation values judged to be valid corresponding to the displacement vectors.

Preferably, according to a fifth aspect, in the motion vector detecting device, the chrominance pixel data includes first chrominance pixel data and second chrominance pixel data, and the pixel data types include the first chrominance pixel data and the second chrominance pixel data.

Preferably, according to a sixth aspect, in the motion vector detecting device, the operational portion includes an operational portion assigning weights to the luminance pixel data heavier than the chrominance pixel data to perform the predetermined inter-pixel calculation when the type of the pixel data subjected to the predetermined inter-pixel calculation is the luminance pixel data.

Preferably, according to a seventh aspect, in the motion vector detecting device, the operational portion includes an operational portion further multiplying the result of the predetermined inter-pixel calculation by 1/K (K>1) when the type of the pixel data subjected to the predetermined inter-pixel calculation is the chrominance pixel data.

Preferably, according to an eighth aspect, in the motion vector detecting device, the operational portion includes an operational portion setting a predetermined number of low-order bit or bits to 0 in the result of the predetermined inter-pixel calculation when the type of the pixel data subjected to the predetermined inter-pixel calculation is the chrominance pixel data.

According to a ninth aspect of the present invention, a motion vector detecting method comprises the step of: (a) providing template block data which defines pixel data in a template block and search window data which defines pixel data in a search window sized to contain the template block, wherein chrominance pixel data is contained in the template block data and the search window data according to a predetermined rule in a chrominance signal containing mode; (b) calculating an evaluation value by performing a predetermined inter-pixel calculation between corresponding pieces of pixel data in the template block data and search window block data which is data in a search window block as a part of the search window, each time the search window block data is varied by using the search window data so that a displacement vector which shows the relative position of the search window block with respect to the template block is varied; and (c) performing a comparison between the evaluation values corresponding to the displacement vectors and detecting a motion vector on the basis of the result of the comparison.

Preferably, according to a tenth aspect, in the motion vector detecting method, the chrominance signal containing mode includes a chrominance signal mode, and the step (a) includes a step of serving such that only the chrominance pixel data is contained in the template block data and the search window data according to the predetermined rule in the chrominance signal mode, the chrominance pixel data including first chrominance pixel data and second chrominance pixel data, and the step (c) comprises a step of judging whether the evaluation values are valid or invalid on the basis of whether the chrominance pixel data types agree or disagree between the corresponding pieces of pixel data in the template block data and the search window block data on the basis of the displacement vectors in the chrominance signal mode, to perform the comparison between the evaluation values judged to be valid corresponding to the displacement vectors.

Preferably, according to an eleventh aspect, in the motion vector detecting method, the chrominance signal containing mode includes a luminance and chrominance mix mode, the step (a) includes a step of serving such that the luminance pixel data and the chrominance pixel data are contained in the template block data and the search window data according to the predetermined rule in the luminance and chrominance mix mode, and the step (c) includes a step of judging whether the evaluation values are valid or invalid on the basis of whether the pixel data types agree or disagree between the corresponding pieces of pixel data in the template block data and the search window block data on the basis of the displacement vectors in the luminance and chrominance mix mode, to perform the comparison between the evaluation values judged to be valid corresponding to the displacement vectors.

Preferably, according to a twelfth aspect, in the motion vector detecting method, the chrominance pixel data includes first chrominance pixel data and second chrominance pixel data, and the pixel data types includes the first chrominance pixel data and the second chrominance pixel data.

Preferably, according to a thirteenth aspect, in the motion vector detecting method, the step (b) includes a step of assigning weights to the luminance pixel data heavier than the chrominance pixel data to perform the predetermined inter-pixel calculation when the type of the pixel data subjected to the predetermined inter-pixel calculation is the luminance pixel data.

Preferably, according to a fourteenth aspect, in the motion vector detecting method, when the type of the pixel data subjected to the predetermined inter-pixel calculation is the chrominance pixel data, the step (b) includes the steps of (b-1) obtaining a result through the predetermined inter-pixel calculation, and (b-2) further multiplying the result obtained in the step (b-1) by 1/K (K>1).

Preferably, according to a fifteenth aspect, in the motion vector detecting method, when the type of the pixel data subjected to the predetermined inter-pixel calculation is the chrominance pixel data, the step (b) includes the steps of (b-1) obtaining a result through the predetermined inter-pixel calculation, and (b-2) setting a predetermined number of lower-order bit or bits to 0 in the result obtained in the step (b-1).

As stated above, according to the motion vector detecting device of the first aspect of the present invention, in the chrominance signal containing mode, the motion vector is detected by using the template block data and search window block data which contain the chrominance pixel data. Therefore the motion vector can be efficiently detected even when the chrominance information is dominant in the image.

According to the motion vector detecting device of the second aspect, the control portion provides a first signal indicating the chrominance signal containing mode to the input portion so that the input portion executes the chrominance signal containing mode operation.

According to the motion vector detecting device of the third aspect, the comparator portion judges whether the evaluation value is valid or invalid on the basis of whether the types of chrominance pixel data agree or disagree between corresponding pieces of pixel data in the template block data and the search window block data. Meaningless evaluation values obtained on the basis of different types of chrominance pixel data can thus be removed to accurately detect the motion vector.

According to the motion vector detecting device of the fourth aspect, in the luminance and chrominance mix mode, the luminance pixel data and the chrominance pixel data are contained in the template block data and the search window data according to the predetermined rule, so that both of the luminance information and the chrominance information can be reflected in the motion vector detection.

In addition, the motion vector detecting device of the fourth aspect judges whether the evaluation value is valid or invalid on the basis of whether the pixel data types agree or disagree between corresponding pieces of pixel data in the template block data and the search window block data, so that meaningless evaluation values obtained from different types of pixel data can thus be removed to accurately detect the motion vector.

According to the motion vector detecting device of the fifth aspect, in the luminance and chrominance mix mode, the luminance information and the chrominance information including information of the first and second chrominance signals can be reflected in the motion vector detection.

According to the motion vector detecting device of the sixth aspect, when the pixel data type is the luminance pixel data, the operational portion performs the predetermined inter-pixel calculation with the luminance pixel data weighted heavier than the chrominance pixel data, so that the luminance information and the chrominance information can both be reflected in the motion vector detection with the luminance information having higher priority.

According to the motion vector detecting device of the seventh aspect, when the type of the pixel data subjected to the predetermined inter-pixel calculation is the chrominance pixel data, the operational portion further multiplies the result of the predetermined inter-pixel calculation by 1/K (K>1) to relatively weight the luminance pixel data.

According to the motion vector detecting device of the eighth aspect, when the type of the pixel data subjected to the predetermined inter-pixel calculation is the chrominance pixel data, the operational portion sets a predetermined number of low-order bit or bits to 0 in the result of the predetermined inter-pixel calculation to relatively weight the luminance pixel data.

According to the motion vector detecting method of the ninth aspect of the present invention, in the chrominance signal containing mode, the motion vector is detected by using the template block data and search window block data which contain the chrominance pixel data. Therefore the motion vector can be efficiently detected even when the chrominance information is dominant in the image.

According to the motion vector detecting method of the tenth aspect, the step (c) judges whether the evaluation value is valid or invalid on the basis of whether the types of the chrominance pixel data agree or disagree between corresponding pieces of pixel data in the template block data and the search window block data. Meaningless evaluation values obtained from different types of chrominance pixel data can thus be removed to accurately detect the motion vector.

According to the motion vector detecting method of the eleventh aspect, in the luminance and chrominance mix mode, the luminance pixel data and the chrominance pixel data are contained in the template block data and the search window data according to the predetermined rule, so that both of the luminance information and the chrominance information can be reflected in the motion vector detection

In addition, in the motion vector detecting method of the eleventh aspect, the step (c) judges whether the evaluation value is valid or invalid on the basis of whether the pixel data types agree or disagree between corresponding pieces of pixel data in the template block data and the search window block data, so that meaningless evaluation values obtained from different types of pixel data can thus be removed to accurately detect the motion vector.

According to the motion vector detecting method of the twelfth aspect, in the luminance and chrominance mix mode, the luminance information and the chrominance information including information of the first and second chrominance signals can be reflected in the motion vector detection.

According to the motion vector detecting method of the thirteenth aspect, when the pixel data type is the luminance pixel data, the step (b) performs the predetermined inter-pixel calculation with the luminance pixel data weighted heavier than the chrominance pixel data, so that the luminance information and the chrominance information can both be reflected in the motion vector detection with the luminance information having higher priority.

According to the motion vector detecting method of the fourteenth aspect, when the type of the pixel data subjected to the predetermined inter-pixel calculation is the chrominance pixel data, the step (b-2) in the step (b) further multiplies the result of the predetermined inter-pixel calculation by 1/K (K>1) to relatively weight the luminance pixel data.

According to the motion vector detecting method of the fifteenth aspect, when the type of the pixel data subjected to the predetermined inter-pixel calculation is the chrominance pixel data, the step (b-2) in the step (b) sets a predetermined number of low-order bit or bits to 0 in the result of the predetermined inter-pixel calculation to relatively weight the luminance pixel data.

The present invention has been made to solve the problem explained earlier, and an object of the invention is to obtain a motion vector detecting device and a motion vector detecting method which can efficiently detect the motion vector even when the chrominance information is dominant in the image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a motion vector detecting device according to a first preferred embodiment of the present invention;

FIG. 2 is an explanation diagram showing a template block and a search area used in the first preferred embodiment;

FIG. 3 is a block diagram schematically showing the internal structure of one of a plurality of element processors provided in the processor array shown in FIG. 1;

FIG. 4 is an explanation diagram showing a calculating portion in the element processor;

FIG. 5 is an explanation diagram showing the internal structure of the processor array;

FIG. 6 is a block diagram showing the internal structure of the input unit shown in FIG. 1;

FIG. 7 is an explanation diagram showing an example of addressing for writing data into a search window memory or a template memory;

FIG. 8 is an explanation diagram showing an example of addressing for reading data from the search window memory or the template memory;

FIG. 9 is a timing chart showing operation of the input unit in the motion vector detecting device of the first preferred embodiment;

FIG. 10 is an explanation diagram showing the template block data stored in the processor array in a chrominance signal mode;

FIG. 11 is an explanation diagram showing the search window block data stored in the processor array when the displacement vector has an even horizontal vector in the chrominance signal mode;

FIG. 12 is an explanation diagram showing the search window block data stored in the processor array when the displacement vector has an odd horizontal vector in the chrominance signal mode;

FIG. 13 is a block diagram showing the internal structure of the summing unit;

FIG. 14 is a block diagram showing part of the internal structure of the comparator unit shown in FIG. 1;

FIG. 15 is an explanation diagram showing the template block data stored in the processor array 10 in a luminance and chrominance mix mode in a second preferred embodiment;

FIG. 16 is an explanation diagram showing the search window block data stored in the processor array when the displacement vector has an even horizontal vector in the luminance and chrominance mix mode;

FIG. 17 is an explanation diagram showing the search window block data stored in the processor array when the displacement vector has an odd horizontal vector in the luminance and chrominance mix mode;

FIG. 18 is a block diagram showing the internal structure of a summing unit in a motion vector detecting device according to a third preferred embodiment of the present invention;

FIG. 19 is a block diagram showing the internal structure of a summing unit in a motion vector detecting device according to a fourth preferred embodiment of the present invention;

FIG. 20 is an explanation diagram showing the template block data stored in the processor array in the luminance and chrominance mix mode in a fifth preferred embodiment;

FIG. 21 is an explanation diagram showing the search window block data stored in the processor array when the displacement vector has an even horizontal vector and an even vertical vector in the luminance and chrominance mix mode;

FIG. 22 is an explanation diagram showing the search window block data stored in the processor array when the displacement vector has an even horizontal vector and an odd vertical vector in the luminance and chrominance mix mode.

### DESCRIPTION OF THE PREFERRED EMBODIMENTS

<First Preferred Embodiment>

FIG. 1 is a block diagram showing the structure of a motion vector detecting device according to a first preferred embodiment of the present invention, where the motion vector detecting device encodes images frame by frame.

As shown in this diagram, the motion vector detecting device has an operational unit 1, an input unit 2, a comparator unit 3, and a control unit 4, where the operational unit 1 contains a processor array 10 and a summing unit 12.

The input unit 2 serves as a data providing portion which receives template data DX based on the current image and search window data DY based on the reference image (an image preceding or following the current image in time) and takes in the template data DX and the search window data DY and provides the data to the operational unit 1 on the basis of a mode signal SM sent from the control unit 4.

On the basis of the data provided from the input unit 2, the operational unit 1 calculates three evaluation values ESa, ESo and ESe about displacement vectors of one template block. The displacement vector will be fully described later.

The comparator unit 3 receives the evaluation values ESa, ESo and ESe for each template block, obtains the minimum values of the evaluation values ESa, ESo and ESe, and outputs the displacement vectors corresponding to the minimum evaluation values as motion vectors MVa, MVo and Mve. In this process, the comparator unit 3 changes the contents of the comparison operation on the basis of the mode signal SM provided from the control unit 4.

The control unit 4 thus supplies the mode signal SM to the input unit 2 and the comparator unit 3. Japanese Patent Application Laid-Open Nos.6-113290 (1994), 7-250328 (1995) and 10-7994 (1998), for example, disclose motion vector detecting devices which have the operational unit 1, the input unit 2, and the comparator unit 3 as the basic components and detect the motion vector on the basis of the absolute differences between the template data DX and the search window data DY.

The processor array 10 in the operational unit 1 is formed with a plurality of element processors PE arranged in an array and outputs absolute differences DIF obtained in the individual element processors PE to the summing unit 12.

The summing unit 12 in the operational unit 1 obtains sums of the absolute differences DIF coming from the processor array 10 according to a predetermined procedure and outputs the three evaluation values ESa, ESo and ESe.

Each element processor PE in the processor array 10 contains part of the template block data; different element processors PE contain different pieces of data. The individual element processors PE calculate components of the evaluation values (absolute differences in this preferred embodiment) which represent the degree of correlation between one template block and one search window block. The search window block is a block which has the same coordinate system as the template block: the search window block has the same dimensions as the template block provided in a search window (search area) which is sized to contain the template block.

The processor array 10 keeps the same contents of template block data during a cycle in which the motion vectors are obtained for the template block.

In the processor array 10, the search window block data is shifted one pixel at a time, for each operation cycle corresponding to one displacement vector.

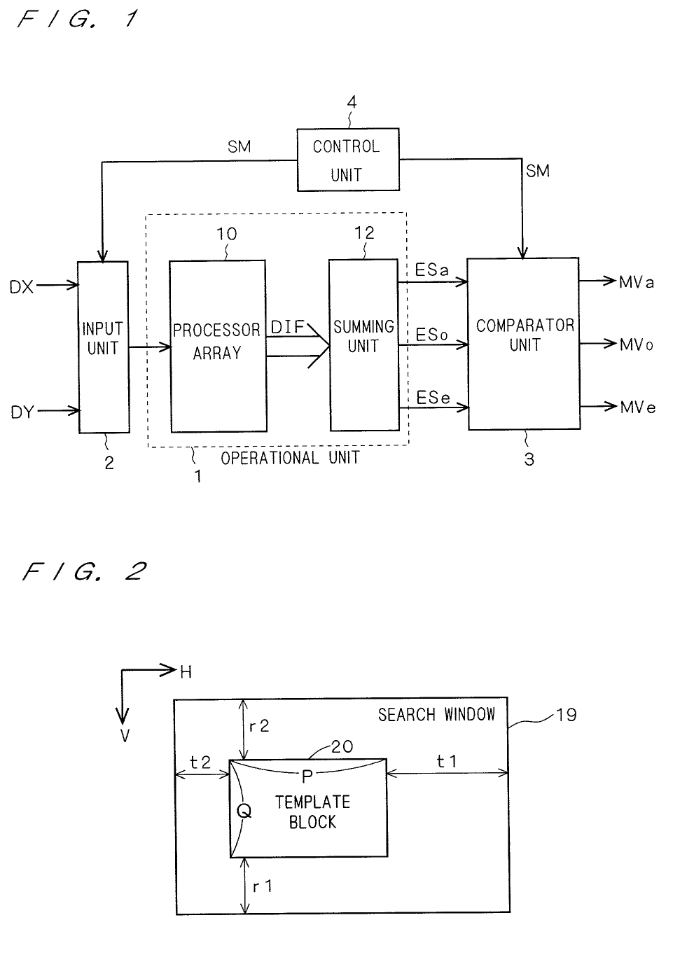

FIG. 2 is an explanation diagram showing the template block and the search window (search area) used in the first preferred embodiment. As shown in this diagram, the template block 20 contains pixels arranged in Q rows and P columns.

The search window 19 has a search area extending from +t1 to −t2 in the horizontal direction and from +r1 to −r2 in the vertical direction. That is to say, the search window 19 contains (t2+P+t1)×(r2+Q+r1) pixels. In the search window 19, the area where it overlaps with the template block 20 (the area where their coordinate positions coincide) is the search window block having the displacement vector “0.”

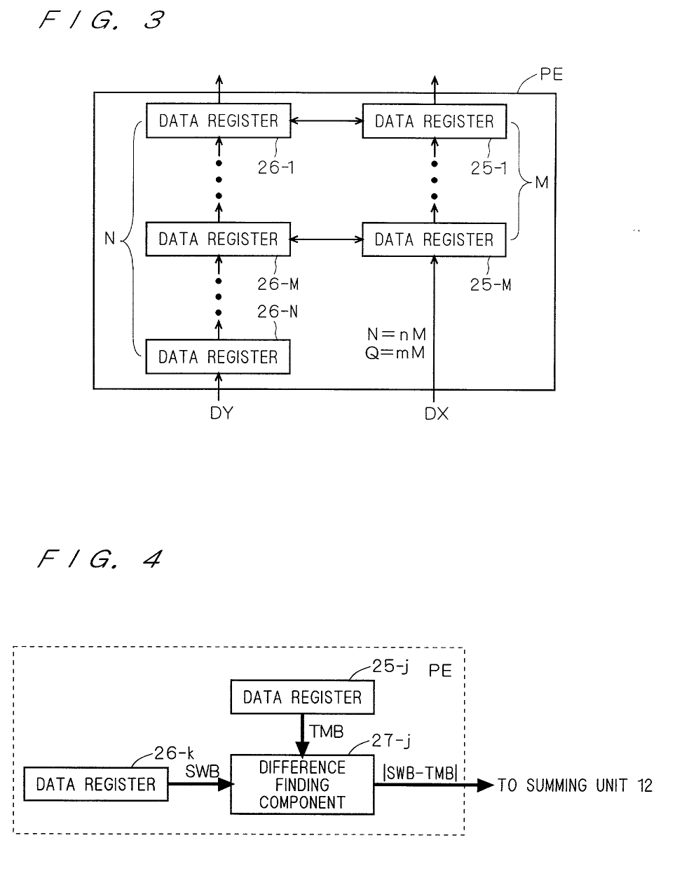

FIG. 3 is a block diagram schematically showing the internal structure of each of the plurality of element processors PE in the processor array 10. As shown in this diagram, part of the template block data is stored in the M data registers 25-1 to 25-M connected in cascade to store the template block data.

Each element processor PE contains N data registers 26-1 to 26-N connected in cascade to store the search window data. N is an integer multiple (n times) of M, i.e. N=nM. The number of rows, Q, of the template block is an integer multiple (m times) of the number of stages, M, of the data registers 25-1 to 25-M, i.e. Q=mM.

The element processor PE performs calculation by using the template block data stored in the M data registers 25-1 to 25-M. In FIG. 3, the data registers 25-1 to 25-M and the data registers 26-1 to 26-M are associated with each other in a one-to-one correspondence.

The data registers 26-1 to 26-N for storing the search window data may be associated in a one-to-one correspondence with the data registers 25-1 to 25-M for storing the template block data (i.e. n=1 and N=M), in which case the calculation is performed by using the data stored in the corresponding registers. The calculation may be performed in other combinations.

FIG. 4 is an explanation diagram showing a calculating portion in the element processor PE. As shown in this diagram, a difference fining component 27-j (j=any of 1 to M) is provided in correspondence with the data register 25-j. That is to say, M difference fining components 27-1 to 27-M are provided in correspondence with the data registers 25-1 to 25-M.

The difference fining component 27-j receives the template block data TMB and the search window block data SWB from the corresponding data register 25-j and data register 26-k (k=any of 1 to N). It then obtains the absolute difference | SWB−TMB | between the two and outputs it to the summing unit 12.

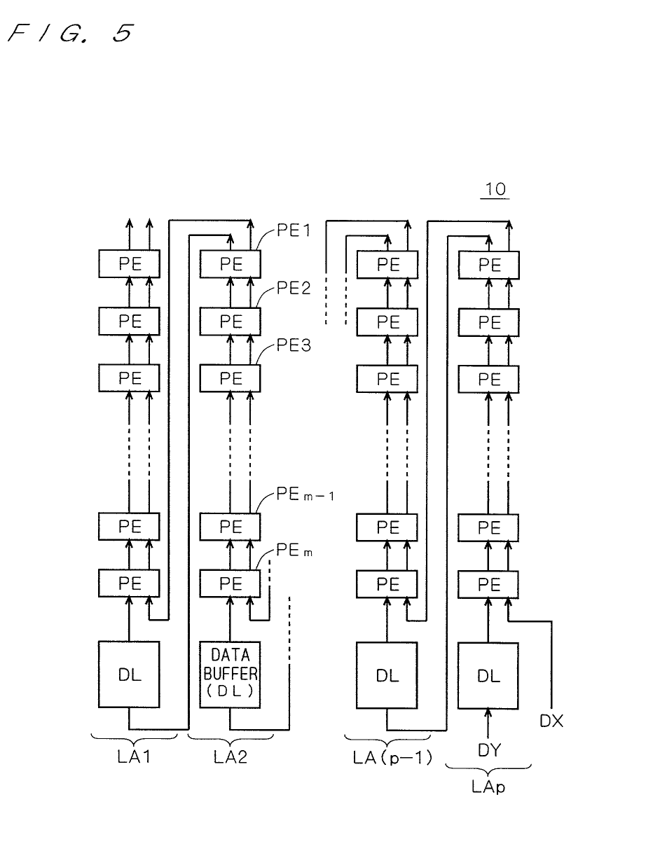

FIG. 5 is an explanation diagram showing the internal structure of the processor array 10. As shown in this diagram, the processor array 10 is formed with linear processor arrays LA1 to LAp arranged in p columns. The linear processor arrays LA1 to LAp are cascade-connected so that they can transfer data to each other; each of the linear processor arrays LA1 to LAp contains the element processors PE1 to PEm constructed as shown in FIGS. 3 and 4, and a data buffer DL for storing R (=r1+r2) pieces of search window block data and serving also as delay means.

The element processors PE1 to PEm in the same linear processor array LA can transfer the search window data and the template block data only in one direction (in the direction from the element processor PEm to the element processor PE1). That is to say, the search window data and the template block data can be transferred only in the single direction between adjacent element processors PE and PE. The search window data in the data buffer DL can be transferred to the element processor PEm in the same linear processor array LA.

For data transfer between adjacent linear processor arrays LAi and LA(i0+1), where i=1 to (p−1), the template block data can be transferred from the element processor PE1 in the linear processor array LA(i+1) to the element processor PEm in the linear processor array LAi, and the search window data can be transferred from the element processor PE1 in the linear processor array LA(i+1) to the data buffer DL in the linear processor array LAi.

In the linear processor array LAp, the element processor PEm receives the template data DX and the data buffer DL receives the search window data DY.

In this way, the search window data is transferred through the element processors PE and the data buffers DL and the template block data is transferred only through the element processors PE. In the search window data, the data stored in the element processors PE1 to PEm in the linear processor arrays LA1 to LAp corresponds to the search window block data.

The data buffers DL have a delay function as stated above, which output the supplied data in the FIFO (first-in first-out) manner. Therefore the data buffers DL may be R data latches having shift function or a register file for storing R pieces of data.

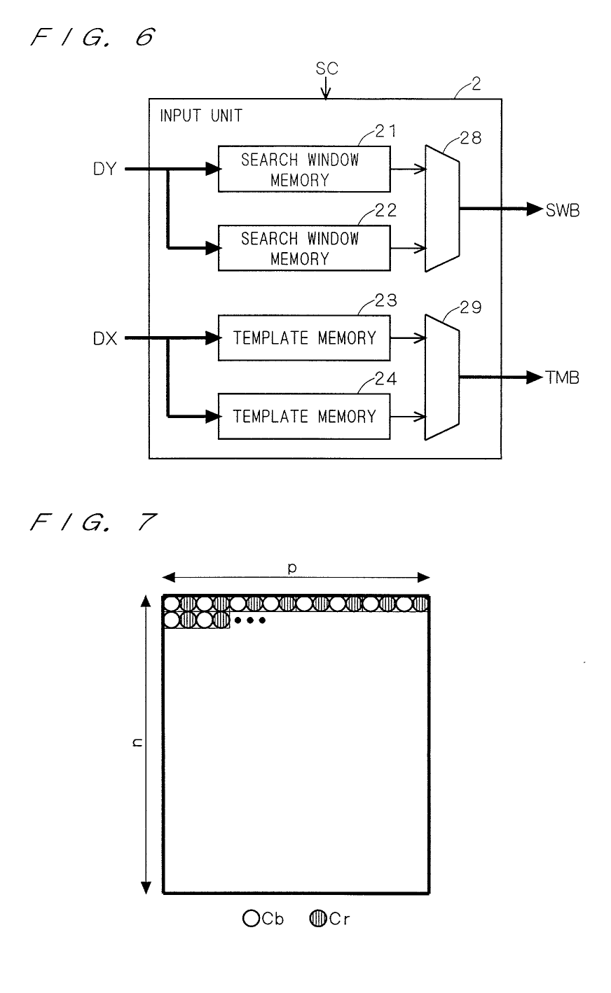

FIG. 6 is a block diagram showing the internal structure of the input unit 2 shown in FIG. 1. As shown in this diagram, the search window memories 21 and 22 receive the search window data DY and the template memories 23 and 24 receive the template data DX.

The selector 28 reads data from one of the search window memories 21 and 22 on the basis of the mode signal SM and outputs the data as the search window block data SWB. The selector 29 reads data from one of the template memories 23 and 24 on the basis of the mode signal SM and outputs the data as the template block data TMB.

The operations of the search window memories 21 and 22 and the selector 28 are controlled by a control signal SC provided from the control unit 4. For example, the search window data Y can be written into the search window memory 21 while data stored in the search window memory 22 is being read through the selector 28; the search window memories 21 and 22 can thus be used versatilely. Similarly, operations of the template memories 23 and 24 and the selector 29 are controlled on the basis of the control signal SC.

In general, data is transferred to the search window memory 21 from the outside of the device (LSI), where data about a plurality of pixels is transferred in each cycle through a multi-bit bus. Since the video signal uses raster input, data about pixels arranged in the horizontal direction is transferred as one word in each cycle.

FIG. 7 is an explanation diagram showing an example of addressing used to write data into the search window memory 21 (22) or the template memory 23 (24) when the mode signal SM indicates a chrominance signal mode. As shown in this diagram, the search window memory 21 has a memory space of n pixels vertically and p pixels horizontally. For convenience, the upper left comer is represented as (1, 1) and the lower right comer as (p, n) hereinafter.

FIG. 7 shows an example in which a total of four pixels of chrominance pixel data Cb and Cr, two horizontal pixels for each, are transferred together as one word. The chrominance pixel data Cb is B (blue)—Y (luminance signal) and the chrominance pixel data Cr is R (red)—Y (luminance signal). On the other hand, when the mode signal SM indicates a luminance signal mode, horizontally succeeding four pixels of the luminance signal are transferred together as one word.

When one word has been transferred, the pixel data is stored from (1, 1) to (4, 1) in the search window memory 21; subsequently the pixel data is written from (1, 1) to (p, n) while updating the write address in the search window memory 21. The number p is set as an even number so that, as shown in FIG. 7, the chrominance pixel data Cb and Cr will not be mixed in the same column.

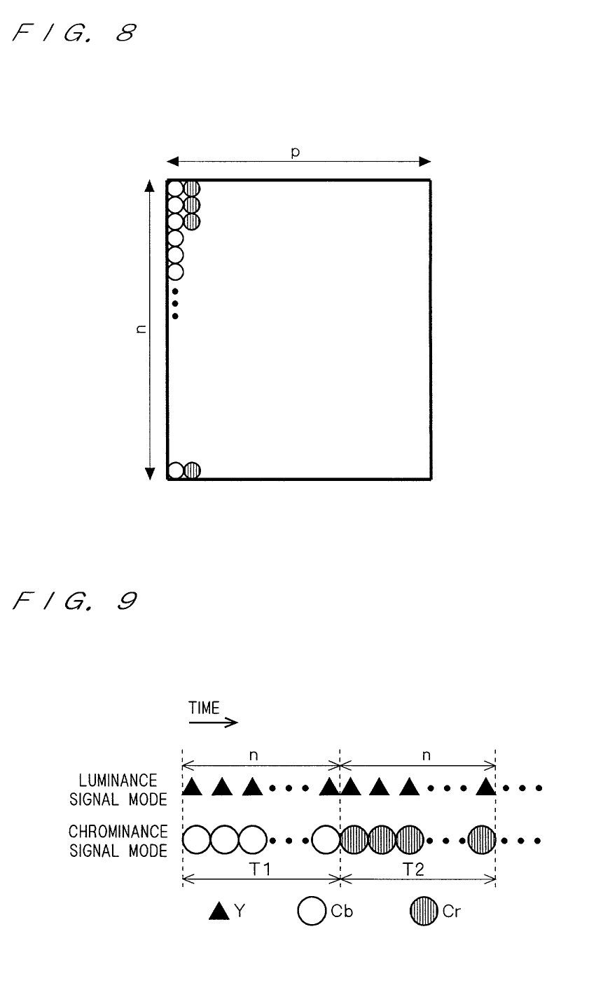

FIG. 8 is an explanation diagram showing an example of addressing used to read data from the search window memory 21 or the template memory 23 when the mode signal SM indicates the chrominance signal mode. It is assumed here that the search window data DY has been written as shown in FIG. 7.

In reading, the data is vertically scanned and sequentially read in the order of (1, 1,), (1, 2), (1, 3) . . . (1, n), (2, 1), (2, 2), (2, 3) . . . (p, n).

In this way, the input unit 2 functions as a data providing portion which, when the mode signal SM indicates the chrominance signal mode, outputs the chrominance pixel data Cb and Cr, n pieces at a time, to the operational unit 1, and which outputs the luminance pixel data Y, n pieces at a time, to the operational unit 1 when the mode signal SM indicates the luminance signal mode.

FIG. 9 is a timing chart showing the operation of the input unit 2 in the motion vector detecting device of the first preferred embodiment. As shown in this diagram, in the luminance signal mode, the input unit 2 outputs only the luminance pixel data Y of the template data DX and the search window data DY, n pieces at a time, as in conventional devices. A motion vector detecting device using the luminance pixel data Y is disclosed in Japanese Patent Application Laid-Open No.6-113290 (1994), for example.

The motion vector detecting device of the first preferred embodiment comprises, in addition, the chrominance signal mode, in which the input unit 2 alternately outputs n pieces of chrominance pixel data Cb and n pieces of chrominance pixel data Cr as shown in FIG. 9.

In the case of the chrominance signal of the 4:2:0 format and the 4:2:2 format used in MPEG2, one set of chrominance pixel data Cb and Cr corresponds to horizontal two pixels of the luminance pixel data in a certain position.

FIG. 10 is an explanation diagram showing the template block data stored in the processor array 10 in the chrominance signal mode. As shown in FIG. 4, p element processors PE are arranged in the horizontal direction and m in the vertical direction. In the chrominance signal mode, as shown in FIG. 10, the chrominance pixel data Cb of the template block data is stored in the odd-numbered columns and the chrominance pixel data Cr is stored in the even-numbered columns.

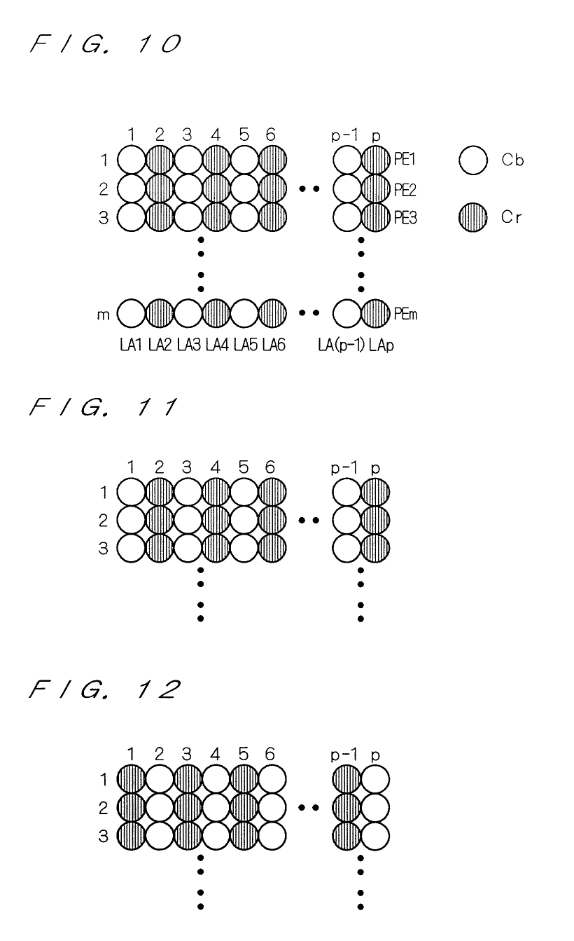

FIG. 11 is an explanation diagram showing the search window block data stored in the processor array 10 when the displacement vector has an even horizontal vector in the chrominance signal mode (when the columns are shifted for an even number of columns).

The displacement vector is a vector which shows the relative position of the search window block with respect to the template block. For example, in FIG. 2, when the search window block is positioned in the upper left corner of the search window 19, then the displacement vector of the search window block with respect to the template block 20 located as shown in FIG. 2 is represented as a composite vector having the horizontal vector −t2 and vertical vector −r2. In the processor array 10 of the first preferred embodiment, the template block data TMB is fixed, and the search window block data SWB is varied to move the search window block in the search window 19 so that the displacement vector is varied.

As shown in FIG. 11, the columns where the chrominance pixel data Cb and Cr exist in the search window block data coincide with those where the template block data is disposed as shown in FIG. 10. Therefore the absolute differences obtained between the template block data TMB and the search window block data SWB in the individual element processors PE are valid for the evaluation value calculation.

In this specification, the chrominance pixel data Cb is represented by the white circle ⊖ and the chrominance pixel data Cr is represented by the hatched circle. However, they can be defined in the opposite way. In any way, as long as the chrominance pixel data Cb and Cr are stored in the corresponding columns in the search window block data and the template block data, the absolute differences between the template block data TMB and the search window block data SWB are valid for the evaluation value calculation.

FIG. 12 is an explanation diagram showing the search window block data stored in the processor array 10 when the displacement vector has an odd horizontal vector in the chrominance signal mode (when the data is shifted for an odd number of columns). As shown in this diagram, the columns where the chrominance pixel data Cb and Cr exist in the search window block data disagree with, and are in the opposite relation to, those in the template block data shown in FIG. 10. The absolute differences between the template block data TMB and the search window block data SWB provided from the element processors PE are therefore invalid for the evaluation value calculation.

Thus, when the search window data is stored and arranged in the processor array 10 as shown in FIG. 11 at the beginning of the motion vector detecting calculation (i.e., when the template block data and the search window block data are set to implement the relation as shown in FIGS. 10 and 11), the horizontal vector of the displacement vector is shifted “1” when one column of calculation ends, and then the search window block data is placed in the state shown in FIG. 12; subsequently the states shown in FIGS. 11 and 12 alternate each time one column is shifted.

Thus, the absolute differences obtained between the template block data TMB and the search window block data SWB in the individual element processors PE are valid when the horizontal vector of the displacement vector is even, and are invalid when it is odd.

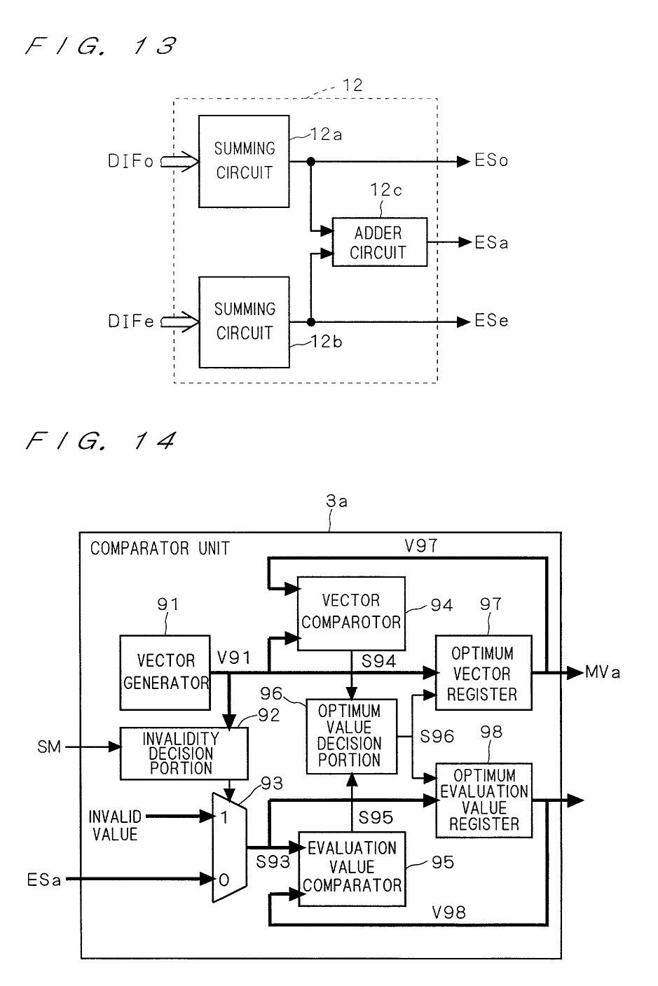

FIG. 13 is a block diagram showing the internal structure of the summing unit 12. As shown in this diagram, the summing unit 12 contains summing circuits 12a and 12b and an adder circuit 12c.

The summing circuit 12a receives all absolute differences DIFo corresponding to the odd sub-template block formed only of the pixels belonging to the odd field (the template block data stored in the element processors PE in the odd rows (PE1, PE3, PE5 . . . )), and it outputs the sum, or the evaluation value ESo, to the outside and to the adder circuit 12c.

The summing circuit 12b receives all absolute differences DIFe corresponding to the even sub-template block formed only of the pixels belonging to the even field (the template block data stored in the element processors PE in the even rows (PE2, PE4, PE6 . . . )), and it outputs the sum, or the evaluation value ESe, to the outside and to the adder circuit 12c

The adder circuit 12c adds the evaluation value ESo and the evaluation value ESe and outputs the total evaluation value ESa.

FIG. 14 is a block diagram showing part of the internal structure of the comparator unit 3 shown in FIG. 1. While this diagram only shows the comparator circuit 3a which receives the evaluation value ESa, the comparator unit 3 further comprises circuits similar to the comparator circuit 3a for the evaluation values ESe and ESo. The three comparator circuits form the comparator unit 3.

As shown in FIG. 14, the comparator circuit 3a contains a vector generator 91, an invalidity decision portion 92, an evaluation value selector 93, a vector comparator 94, an evaluation value comparator 95, an optimum value decision portion 96, an optimum vector register 97, and an optimum evaluation value register 98.

The vector generator 91 generates a vector V91 as the displacement vector corresponding to the evaluation value ESa. The vector generator 91 is triggered by, e.g. a reset input, and generate the vector V91 which varies it in time.

The evaluation value selector 93 receives an invalid value at its “1” input and the evaluation value ESa at its “0” input. It selects one of the “1” input and “0” input under control by the invalidity decision portion 92 and outputs it as the selected evaluation value S93. The invalid value can be an arbitrary value which is larger than any possible values which the evaluation value ESa can take, for example.

The invalidity decision portion 92 judges whether the evaluation value ESa is valid or invalid on the basis of the mode signal SM and the vector V91 and controls the evaluation value selector 93 on the basis of the decision. That is to say, when judging on validity, the invalidity decision portion 92 causes the evaluation value selector 93 to output its “0” input (the evaluation value ESa) as the selected evaluation value S93, and when judging on invalidity, it causes the evaluation value selector 93 to output its “1” input (the invalid value) as the selected evaluation value S93.

When the invalidity decision portion 92 detects the outside of the effective area (screen), it judges that it is invalid regardless of the mode signal SM. For example, when the vector V91 has a negative vertical vector (which indicates upward on the screen) when the template block is located in the upper end of the screen, it judges that the evaluation value ESa is invalid since it is out of the effective area (screen). Though not shown in FIG. 14, the invalidity decision portion 92 in the comparator circuit 3a can obtain information about the position of the template block on the screen by a known method.

When the mode signal SM indicates the chrominance signal mode and the vector V91 has an odd horizontal vector, the invalidity decision portion 92 judges that the evaluation value ESa is invalid even when it is inside the effective area. For example, it checks the LSB of the horizontal vector value of the vector V91 and judges whether the horizontal vector value is even or odd on the basis of whether the LSB is 0 or 1.

When the mode signal SM indicates the luminance signal mode, the invalidity decision portion 92 judges that the evaluation value ESa is valid as long as it is inside the effective area, regardless of whether the horizontal vector of the vector V91 is even or odd.

The vector comparator 94 compares the optimum vector V97 stored in the optimum vector register 97 and the current vector V91, evaluates their priorities (e.g. which vector is larger), and outputs the comparison result S94, showing which priority is higher, to the optimum value decision portion 96.

The evaluation value comparator 95 compares the optimum evaluation value V98 stored in the optimum evaluation value register 98 and the selected evaluation value S93 or the current evaluation value, and outputs the comparison result S95, showing which evaluation value is larger, to the optimum value decision portion 96.

When the comparison result S95 shows that the selected evaluation value S93 is smaller than the optimum evaluation value V98, the optimum value decision portion 96 provides a control signal S96 to the optimum vector register 97 and the optimum evaluation value register 98 in order to store the vector V91 in the optimum vector register 97 to update the optimum vector V97 and also in order to store the selected evaluation value S93 in the optimum evaluation value register 98 to update the optimum evaluation value V98.

Also when the comparison result S95 shows that the selected evaluation value S93 and the optimum evaluation value V98 agree with each other and the comparison result S94 shows that the priority of the vector V91 is higher than that of the optimum vector V97, the optimum value decision portion 96 provides the control signal S96 to the optimum vector register 97 and the optimum evaluation value register 98 in order to store the vector V91 in the optimum vector register 97 to update the optimum vector V97 and also in order to store the selected evaluation value S93 in the optimum evaluation value register 98 to update the optimum evaluation value V98.

On the other hand, when the comparison result S95 shows that the selected evaluation value S93 is larger than the optimum evaluation value V98, it provides the control signal S96 to the optimum vector register 97 and the optimum evaluation value register 98 in order to cause the optimum vector register 97 to keep the optimum vector V97 and the optimum evaluation value register 98 to keep the optimum evaluation value V98.

In this way, the optimum vector register 97 and the optimum evaluation value register 98 keep the optimum vector V97 and the optimum evaluation value V98, or update them with the vector V91 and the selected evaluation value S93, on the basis of the control signal S96.

The optimum vector V97 finally outputted from the optimum vector register 97 is the motion vector MVa. Though not shown in FIG. 1, the comparator circuit 3a externally outputs the optimum evaluation value V98 from the optimum evaluation value register 98 as the evaluation value corresponding to the motion vector Mva.

As described so far, when the mode signal SM indicates the chrominance signal mode, the comparator circuit 3a does not update the optimum vector V97 with a meaningless vector V91 so that the motion vector MVa can be accurately detected on the basis of the two kinds of chrominance signals.

For example, when m=p=16 in the structure shown in FIG. 5, the motion vector can be detected in the luminance signal mode on the basis of the evaluation values ESa corresponding to the sums of the absolute differences for the full sample of 256 pixels, and the motion vector can be detected in the chrominance signal mode on the basis of the evaluation values ESa corresponding to the sums of the absolute differences for the 4:2:2 format full sample of 128 pixels×two kinds (the chrominance pixel data Cb and Cr).

In this way, the motion vector detecting device of the first preferred embodiment changes the mode between the luminance signal mode and the chrominance signal mode with the mode signal SM. It can therefor accurately detect the motion vector on the basis of the luminance signal, as is done in conventional devices, and also on the basis of the chrominance signal. It is thus possible to efficiently detect the motion vector even when the chrominance information is dominant in the image.

The horizontal vector value of the displacement vector of the chrominance signal is ½ of the horizontal vector value of the luminance signal. Therefore, when outputting the motion vector MVa, the comparator circuit 3a may halve the horizontal vector of the optimum vector V97 in the luminance signal mode so that the luminance signal mode and the chrominance signal mode can be performed conveniently on the same scale.

When the operation of the motion vector detecting device of the first preferred embodiment is considered from a method viewpoint, it performs a motion vector detecting method comprising the steps (1) to (3) shown below.

(1) In the chrominance signal mode, the input unit 2 performs a step of serving such that the chrominance pixel data Cb and the chrominance pixel data Cr are contained in the template block data TMB and the search window data according to a rule of reading the chrominance pixel data Cb n pieces at a time and the chrominance pixel data Cr n pieces at a time.

(2) Each time the search window block data SWB is varied by using the search window data so that the displacement vector showing the relative position of the search window block with respect to the template block is changed, the operational unit 1 performs a step of calculating the evaluation value ESa (ESo, ESe) by obtaining the absolute differences between corresponding pieces of pixel data in the template block data TMB and the search window block data SWB.

(3) In the chrominance signal mode, the comparator unit 3 performs a step of judging whether the evaluation value ESa (ESo, ESe) is valid or invalid on the basis of whether the horizontal vector of the vector V91, or the displacement vector, is an even number or an odd number and performing a comparison operation to obtain the minimum value among the evaluation values ESa judged to be valid corresponding to the vectors V91, and thereby detecting the motion vector MVa (MVe, MVo).

<Second Preferred Embodiment>

A second preferred embodiment shows a motion vector detecting device which further comprises a luminance and chrominance mix mode. Its device structure is the same as that shown in FIG. 1 in the first preferred embodiment except that the mode signal SM also indicates the luminance and chrominance mix mode.

When the input unit 2 receives the mode signal SM indicating the luminance and chrominance mix mode, it assigns the search window memory 21 to the luminance signal and the search window memory 22 to the chrominance signal, for example.

That is to say, in writing the search window data DY, the luminance pixel data Y is written in the search window memory 21 and the chrominance pixel data Cb and Cr are written as shown in FIG. 7 in the search window memory 22.

In reading, n pixels are read from the search window memory 21 in the order of (1, 1), (1, 2), (1, 3) . . . (1, n), and then n pixels are read from the search window memory 22 in the order of (2, 1), (2, 2), (2, 3) . . . (2, n). This operation is repeated and n pixels of the luminance pixel data Y and n pixels of the chrominance pixel data Cr are sequentially transferred to the operational unit 1. When the pixels in the odd-numbered columns are read from the search window memory 22, n pixels of the chrominance pixel data Cb and n pixels of the luminance pixel data Y are sequentially transferred to the operational unit 1.

Like the search window memories 21 and 22, the template memories 23 and 24 are also assigned respectively to the luminance signal and the chrominance signal so that the data can be read and written in the same way.

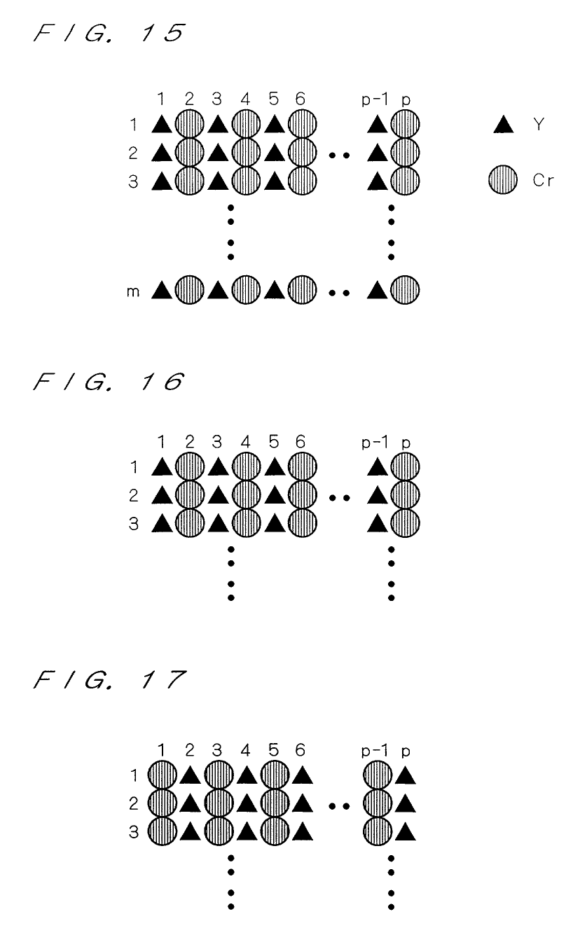

FIG. 15 is an explanation diagram showing the template block data stored in the processor array 10 in the luminance and chrominance mix mode. As shown in this diagram, the luminance pixel data Y is stored in the odd columns and the chrominance pixel data Cr is stored in the even columns.

FIG. 16 is an explanation diagram showing the search window block data stored in the processor array 10 when the displacement vector has an even horizontal vector in the luminance and chrominance mix mode. As shown in this diagram, the columns where the luminance pixel data Y and the chrominance pixel data Cr exist in the search window block data agree with those in the template block data stored as shown in FIG. 15. Therefore the absolute differences obtained between the template block data TMB and the search window block data SWB in the individual element processors PE are valid for the evaluation value calculation.

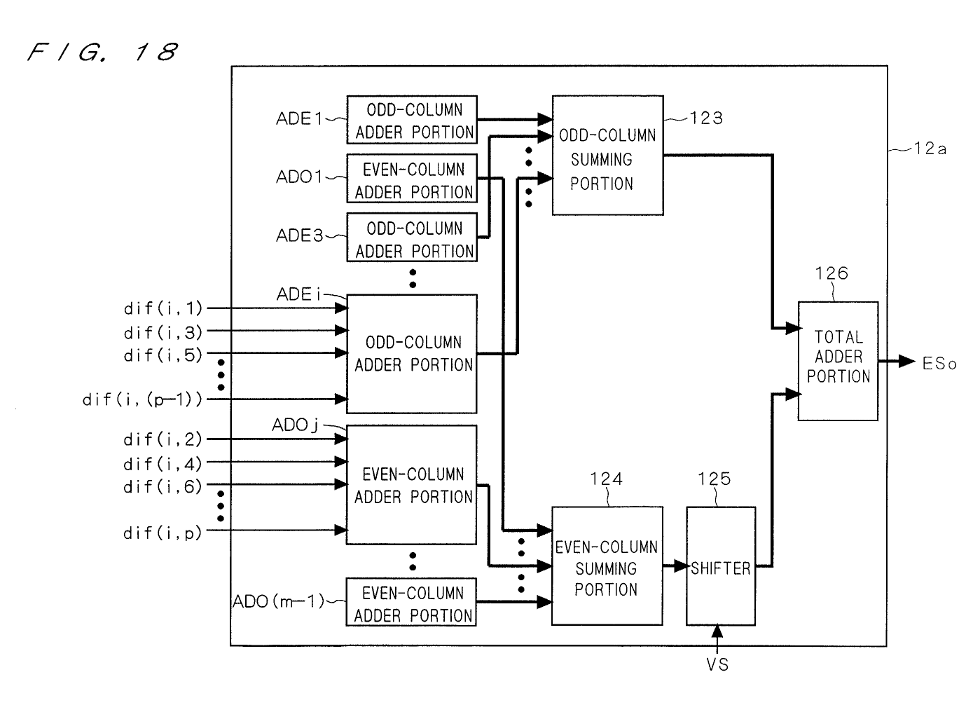

FIG. 17 is an explanation diagram showing the search window block data stored in the processor array 10 when the displacement vector has an odd horizontal vector in the luminance and chrominance mix mode. As shown in this diagram, the columns where the luminance pixel data Y and the chrominance pixel data Cr exist in the search window block data disagree with, and are in the opposite relation to, those in the template block data shown in FIG. 15. Therefore the absolute differences obtained between the template block data TMB and the search window block data SWB in the individual element processors PE are invalid for the evaluation value calculation.

Thus, when the search window data is stored in the processor array 10 as shown in FIG. 16 at the beginning of the motion vector detecting calculation, the horizontal vector of the displacement vector is shifted “1” when one column of calculation is finished and the data is placed in the state shown in FIG. 17. Subsequently the states shown in FIGS. 16 and 17 alternate each time one column is shifted.

Thus, the absolute differences obtained between the template block data TMB and the search window block data SWB in the individual element processors PE are valid when the horizontal vector of the displacement vector is even and invalid when it is odd.

Accordingly, when the mode signal SM indicates the luminance and chrominance mix mode, the comparator unit 3 operates in the same way as when the mode signal SM indicates the chrominance signal mode, and it does not update the optimum vector V97 with meaningless vectors V91. The motion vector MVa can thus be accurately detected on the basis of the luminance signal and one kind of chrominance signal.

For example, when m=p=16 in the structure shown in FIG. 5, the motion vector can be detected in the luminance signal mode on the basis of the evaluation values ESa corresponding to the sums of the absolute differences for the full sample of 256 pixels, and the motion vector can be detected in the luminance and chrominance mix mode on the basis of the evaluation values ESa corresponding to the sums of the absolute differences for the 4:2:0 format full sample of 128 pixels (the chrominance pixel data Cb or Cr) and the ½ sub-sample of the luminance signal.

As explained so far, the motion vector detecting device of the second preferred embodiment appropriately changes the mode among the luminance signal mode, the chrominance signal mode, and the luminance and chrominance mix mode by using the mode signal SM, and it can thus accurately detect the motion vector on the basis of the luminance signal, as is done in conventional devices, and also on the basis of the chrominance information or a mixture of the chrominance information and the luminance information.

When the operation of the motion vector detecting device of the second preferred embodiment is considered in a method viewpoint, it performs a motion vector detecting method comprising the steps (1) to (3) shown below.

(1) In the luminance and chrominance mix mode, the input unit 2 performs a step of serving such that the luminance pixel data Y and the chrominance pixel data Cr are contained in the template block data and the search window data according to a rule of reading the luminance pixel data Y n pieces at a time and the chrominance pixel data Cr n pieces at a time.

(2) Each time the search window block data SWB is varied by using the search window data so that the displacement vector showing the relative position of the search window block with respect to the template block is varied, the operational unit 1 performs a step of calculating the evaluation value ESa (ESo, ESe) by obtaining the absolute differences between corresponding pieces of pixel data in the template block data TMB and the search window block data SWB.

(3) In the luminance and chrominance mix mode, the comparator unit 3 performs a step of judging whether the evaluation values ESa (ESo, ESe) are valid or invalid on the basis of whether the horizontal vector of the vector V91, or the displacement vector, is even or odd and performing a comparison operation to obtain the minimum value among the evaluation values ESa judged to be valid corresponding to the vectors V91, and thereby detecting the motion vector MVa (Mve, MVo).

<Third Preferred Embodiment>

FIG. 18 is a block diagram showing the internal structure of the summing unit in a motion vector detecting device according to a third preferred embodiment of the present invention. FIG. 18 shows the summing circuit 12a in the summing unit 12 shown in FIG. 13. The structure of the device is the same as that shown in FIG. 1 in the first preferred embodiment and the configuration and the contents of operation except those of the summing unit 12 are the same as those shown in the second preferred embodiment.

As shown in this diagram, the summing circuit 12a receives the absolute differences in the odd rows 1, 3 . . . (m−1) from the linear processor arrays LA1 to LAp. Among the absolute differences in the odd rows, the odd-column adder portions ADO1, ADO3 . . . ADO(m−1) receive the absolute differences in the odd columns, and the even-column adder portions ADE1, ADE3 . . . ADE(m−1) receive the absolute differences in the even columns. It is assumed in FIG. 18 that m is an even number.

For example, the odd-column adder portion ADOi (i=an odd number from 1 to (m−1)) adds together the absolute differences dif(i, 1), dif(i, 3), dif(i, 5) . . . dif(i, (p−1)) obtained from the element processors PEi in the linear processor arrays LA1, LA3, LA5 . . . LA(p−1) and outputs the result to the odd-column summing portion 123.

Similarly, the even-column adder portion ADEi adds together the absolute differences dif(i, 2), dif(i, 4), dif(i, 6) . . . dif(i, p) obtained from the element processors PEi in the linear processor arrays LA2, LA4, LA6 . . . LAp and outputs the result to the even-column summing portion 124.

The odd-column summing portion 123 adds together the results coming from the odd-column adder portions ADO1, AD03 . . . ADO(m−1) and outputs the odd-column sum total to the total adder portion 126.

The even-column summing portion 124 adds together the results provided from the even-column adder portions ADE1, ADE3 . . . ADE(m−1) and outputs the even-column sum total to the shifter 125.

The shifter 125 shifts the even-column sum total to the right for an amount of shift indicated by a shift value VS and outputs the shifted even-column sum total to the total adder portion 126. The shift value VS is set at “0” in the luminance signal mode and at an arbitrary value of 1 or larger in the luminance and chrominance mix mode. The shifted even-column sum total is therefore smaller than the even-column sum total by the amount of shift.

The total adder portion 126 adds together the odd-column sum total provided from the odd-column summing portion 123 and the shifted even-column sum total provided from the shifter 125 and outputs the evaluation value ESo.

The summing circuit 12b is constructed in the same way as the summing circuit 12a: i.e. it is formed with a plurality of odd-column adder portions, a plurality of even-column adder portions, and components equivalent to the odd-column summing portion 123, even-column summing portion 124, shifter 125, and total adder portion 126 shown in the summing circuit 12a. The summing circuit 12b receives the absolute differences in the even rows 2, 4 . . . m from the linear processor arrays LA1 to LAp, and the plurality of odd-column adder portions receive the absolute differences in the odd columns and the plurality of even-column adder portions receive the absolute differences in the even columns.

As described above, the motion vector detecting device of the third preferred embodiment shifts the even-column sum total to the right in the luminance and chrominance mix mode to obtain the shifted even-column sum total, thereby reducing the weight of the even-column sum total relative to that of the odd-column sum total. This enables accurate motion vector detection in which the luminance signal is given higher priority than the chrominance signal and large errors of the chrominance signal are not detected as the motion vector.

When the amount of shift in the luminance and chrominance mix mode is fixed at “1,” the shift value VS can be expressed with only one bit, i.e. with a minimum increase of the software.

When the operation of the motion vector detecting device of the third preferred embodiment is considered in a method viewpoint, it is an improvement on the step (2) in the second preferred embodiment, which is a motion vector detecting method having the improved step (2) shown below.

Improved step (2): In the step (2) of the second preferred embodiment, when the displacement vector has an even horizontal vector and the pixel data type subjected to the absolute difference calculation is the chrominance pixel data, the shifter 125 shifts the even-column sum total to the right for the number of bits indicated by the shift value VS to obtain the shifted even-column sum total, and the shifted even-column sum total and the odd-column sum total are added together to obtain the evaluation value ESa (ESo, ESe).

<Fourth Preferred Embodiment>

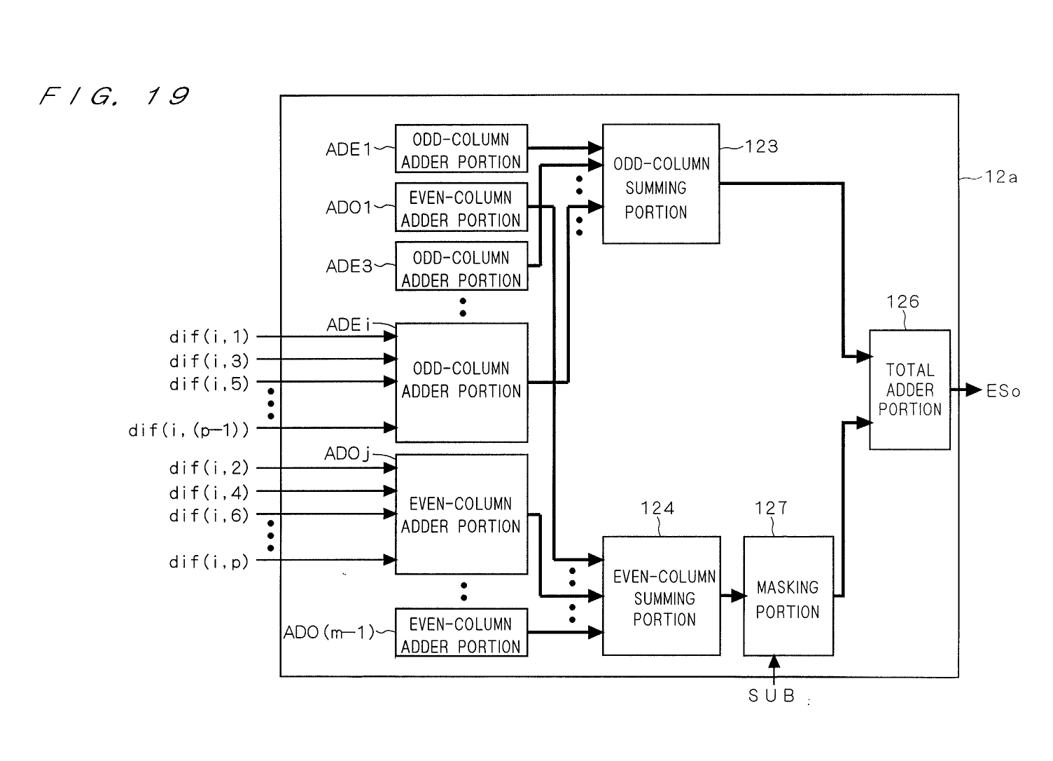

FIG. 19 is a block diagram showing the internal structure of the summing unit in a motion vector detecting device according to a fourth preferred embodiment of the present invention. FIG. 19 shows the summing circuit 12a in the summing unit 12 shown in FIG. 13. The device structure is the same as that shown in FIG. 1 in the first preferred embodiment and the configuration and the contents of operation other than those of the summing unit 12 are the same as those shown in the second preferred embodiment.

As shown in this diagram, the summing circuit 12a receives the absolute differences in the odd rows 1, 3 . . . (m−1) from the linear processor arrays LA1 to LAp. Then, as in the third preferred embodiment, the odd-column adder portions ADO, ADO3 . . . ADO(m−1) receive the odd-column absolute differences in the odd rows and the even-column adder portions ADE1, ADE3 . . . ADE(m−1) receive the even-column absolute differences in the odd rows.

The odd-column summing portion 123 adds together the results provided from the odd-column adder portions ADO1, AD03 . . . ADO(m−1) and outputs the odd-column sum total to the total adder portion 126.

The even-column summing portion 124 adds together the results provided from the even-column adder portions ADE1, ADE3 . . . ADE(m−1) and outputs the even-column sum total to the masking portion 127.

The masking portion 127 zeros (masks) a predetermined number of low-order bits in the even-column sum total, leaving the remaining bits from the MSB effective on the basis of the number of effective bits indicated by an effective bit number indicating value VB. The masking portion 127 then outputs the masked even-column sum total to the total adder portion 126. The effective bit number indicating value VB indicates all bits in the luminance signal mode and indicates a smaller number than the total number of bits in the luminance and chrominance mix mode.

The total adder portion 126 adds the odd-column sum total provided from the odd-column summing portion 123 and the masked even-column sum total provided from the masking portion 127 and outputs the evaluation value ESo.

In this way, in the luminance and chrominance mix mode, the motion vector detecting device of the fourth preferred embodiment makes only part of the even-column sum total effective according to the number of effective bits counted from the MSB. Accordingly, when the absolute difference sum total of the chrominance signal is very large (for example, when the template data and the search window data differ in color), the effect of the chrominance signal can be reflected in the evaluation value. That is to say, when the evaluation value of the luminance signal (the odd-column sum total) is small but the evaluation value of the chrominance signal (the even-column sum total) is large, the vector is not detected as the motion vector (the optimum vector).

The luminance signal can be weighted relative to the chrominance signal in the range where the masking portion 127 provides the mask.

When the operation of the motion vector detecting device of the fourth preferred embodiment is considered in a method viewpoint, it is an improvement on the step (2) of the second preferred embodiment, which is a motion vector detecting method having the improved step (2) shown below.

Improved step (2): In the step (2) of the second preferred embodiment, when the displacement vector has an even horizontal vector and the pixel data type subjected to the absolute difference calculation is the chrominance pixel data, the masking portion 127 masks the even-column sum total to set its low-order bit or bits to 0, except effective bits following the MSB, on the basis of the number of effective bits indicated by the effective bit number indicating value VB, and the masked even-column sum total thus obtained and the odd-column sum total are added together to obtain the evaluation value ESa (ESo, ESe).

<Fifth Preferred Embodiment>

A fifth preferred embodiment shows a motion vector detecting device which provides a further variation of the contents of operation of the input unit 2 in the luminance and chrominance mix mode of the second preferred embodiment. The device structure is the same as that shown in FIG. 1 in the first preferred embodiment and the contents of operation are the same as those of the second preferred embodiment except the operation of the input unit 2 and the invalidity decision portion 92 in the comparator circuit 3a.

When the input unit 2 receives the mode signal SM indicating the luminance and chrominance mix mode, it assigns the search window memory 21 to the luminance signal and the search window memory 22 to the chrominance signal, for example.

That is to say, in writing the search window data DY, the luminance pixel data Y is written in the search window memory 21 and the chrominance pixel data Cb and Cr are written as shown in FIG. 7 in the search window memory 22. It should be noted that the chrominance signal is set in the 4:2:0 format and therefore two pieces of chrominance pixel data vertically succeeding in FIG. 7 have the same value. For example, the chrominance pixel data Cb (1, 1) and (1, 2) take the same value.

In reading, n pixels are read from the search window memory 21 in the order of (1, 1), (1, 2), (1, 3) . . . (1, n) and then n pixels are read from the search window memory 22 in the order of (1, 1), (2, 2), (1, 3), (2, 4) . . . (2, n). This operation is repeated and n pixels of luminance pixel data Y and a total of n pixels of chrominance pixel data Cb and Cr are sequentially transferred to the operational unit 1.

Like the search window memories 21 and 22, the template memories 23 and 24 are also assigned to the luminance signal and the chrominance signal so that the data can be read and written in the same way.

FIG. 20 is an explanation diagram showing the template block data stored in the processor array 10 when the mode signal SM indicates the luminance and chrominance mix mode. As shown in this diagram, the luminance pixel data Y is stored in the odd columns and the chrominance pixel data Cr and the chrominance pixel data Cr are stored in the even columns.

FIG. 21 is an explanation diagram showing the search window block data stored in the processor array 10 when the displacement vector has an even horizontal vector and an even vertical vector in the luminance and chrominance mix mode. As shown in this diagram, the columns where the luminance pixel data Y and the chrominance pixel data Cb and Cr exist in the search window block data agree with those in the template block data shown in FIG. 20. The absolute differences obtained between the template block data TMB and the search window block data SWB in the individual element processors PE are therefore valid for the evaluation value calculation.

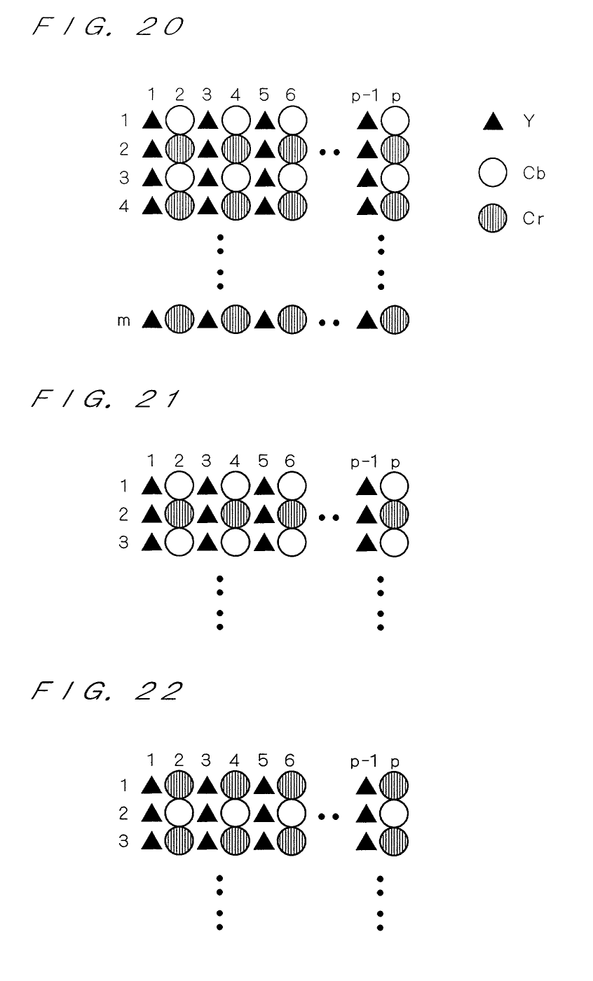

FIG. 22 is an explanation diagram showing the search window block data stored in the processor array 10 when the displacement vector has an even horizontal vector and an odd vertical vector in the luminance and chrominance mix mode. As shown in this diagram, the rows where the luminance pixel data Y and the chrominance pixel data Cb and Cr exist in the search window block data disagree with, and are in the opposite relation to, those in the template block data shown in FIG. 20. Therefore the absolute differences obtained between the template block data TMB and the search window block data SWB in the individual element processors PE are invalid for the evaluation value calculation.

In this way, the absolute differences between the template block data TMB and the search window block data SWB obtained in the individual element processors PE are valid when the horizontal and vertical vectors of the displacement vector are even, and they are invalid otherwise.

Accordingly, when the mode signal SM indicates the luminance and chrominance mix mode, the invalidity decision portion 92 in the comparator unit 3 (see FIG. 14) controls the evaluation value selector 93 to make the evaluation value ESa valid only when the horizontal vector and the vertical vector of the vector V91 are both even, so that the optimum vector V97 is not updated with meaningless vector V91, thus enabling accurate detection of the motion vector MVa on the basis of the luminance signal and the two kinds of chrominance signals.

For example, when m=p=16 in the structure shown in FIG. 5, the motion vector can be detected in the luminance signal mode on the basis of the evaluation values ESa corresponding to the absolute difference sums of the full sample of 256 pixels, and the motion vector can be detected in the luminance and chrominance mix mode on the basis of the evaluation values ESa corresponding to the absolute difference sums of the 4:2:2: format full sample of 128 pixels (the chrominance pixel data Cb or Cr) and the ½ sub-sample of the luminance signal.

In this way, in the motion vector detecting device of the fifth preferred embodiment, the mode signal SM appropriately switches the mode among the luminance signal mode, the chrominance signal mode, and the luminance and chrominance mix mode, and therefore the motion vector can be accurately detected on the basis of the luminance signal, as is done in conventional devices, and also on the basis of the two kinds of chrominance signals or the mixture of the two kinds of chrominance signals and the luminance signal.

The same effect as that of the third preferred embodiment can be obtained when the summing unit 12 (the summing circuit 12a) shown in FIG. 18 in the third preferred embodiment is used as the summing unit 12 of the motion vector detecting device of the fifth preferred embodiment

Also, the same effect as that of the fourth preferred embodiment can be obtained when the summing unit 12 (the summing circuit 12a) shown in FIG. 19 in the fourth preferred embodiment is used as the summing unit 12 of the motion vector detecting device of the fifth preferred embodiment.

When the operation of the motion vector detecting device of the fifth preferred embodiment is considered in a method viewpoint, it is a motion vector detecting method comprising the steps (1) to (3) shown below.

(1) In the luminance and chrominance mix mode, the input unit 2 performs a step of serving such that the luminance pixel data Y, the chrominance pixel data Cb, and the chrominance pixel data Cr are contained in the template block data TMB and the search window data according to a rule of reading the luminance pixel data Y n pieces at a time and the chrominance pixel data Cb and the chrominance pixel data Cr n/2 pieces for each at a time.

(2) Each time the search window block data SWB is varied by using the search window data so that the displacement vector showing the relative position of the search window block with respect to the template block is changed, the operational unit 1 performs a step of calculating the evaluation value ESa (ESo, ESe) by obtaining the absolute differences between corresponding pieces of pixel data in the template block data TMB and the search window block data SWB.

(3) In the luminance and chrominance mix mode, the comparator unit 3 performs a step of judging whether the evaluation values ESa (ESo, ESe) are valid or invalid on the basis of whether or not the horizontal vector and the vertical vector of the vector V91, or the displacement vector, are both even, and performing a comparison operation to obtain the minimum value among the evaluation values ESa corresponding to the vectors V91 judged to be valid, and thereby detecting the motion vector MVa (MVe, MVo).

While the invention has been described in detail, the foregoing description is in all aspects illustrative and not restrictive. It is understood that numerous other modifications and variations can be devised without departing from the scope of the invention.

What is claimed is:

1. A motion vector detecting device comprising:
a data providing portion for providing template block data which defines pixel data in a template block and search window data which defines pixel data in a search window sized to contain said template block, said data providing portion serving such that chrominance pixel data is contained in said template block data and said search window data according to a predetermined rule in a chrominance signal containing mode;
an operational portion for calculating an evaluation value by performing a predetermined inter-pixel calculation between corresponding pieces of pixel data in said template block data and search window block data which is data in a search window block as a part of said search window, each time said search window block data is varied by using said search window data so that a displacement vector which shows a change in position of said template block from an initial position in said search window is varied; and
a comparator portion for performing a comparison between said evaluation values corresponding to said displacement vectors and detecting a motion vector on the basis of the result of the comparison.

2. The motion vector detecting device according to claim 1, further comprising:
a control portion for outputting a mode signal to said input portion, said mode signal indicating whether the mode is said chrominance signal containing mode.

3. The motion vector detecting device according to claim 1, wherein
said chrominance signal containing mode includes a chrominance signal mode,
said data providing portion includes a data providing portion serving such that only said chrominance pixel data is contained in said template block data and said search window data according to said predetermined rule in said chrominance signal mode, said chrominance pixel data including first chrominance pixel data and second chrominance pixel data,
said control portion outputs said mode signal also to said comparator portion, and
said comparator portion includes a comparator portion judging whether said evaluation values are valid or invalid on the basis of whether the chrominance pixel data types agree or disagree between the corresponding pieces of pixel data in said template block data and said search window block data on the basis of said displacement vectors in said chrominance signal mode, to perform said comparison between said evaluation values judged to be valid corresponding to said displacement vectors.

4. The motion vector detecting device according to claim 1, wherein
said chrominance signal containing mode includes a luminance and chrominance mix mode,
said data providing portion includes a data providing portion serving such that said luminance pixel data and said chrominance pixel data are contained in said template block data and said search window data according to said predetermined rule in said luminance and chrominance mix mode,
said control portion outputs said mode signal also to said comparator portion, and
said comparator portion includes a comparator portion judging whether said evaluation values are valid or invalid on the basis of whether the pixel data types agree or disagree between the corresponding pieces of pixel data in said template block data and said search window block data on the basis of said displacement vectors in said luminance and chrominance mix mode, to perform said comparison between said evaluation values judged to be valid corresponding to said displacement vectors.

5. The motion vector detecting device according to claim 4, wherein
said chrominance pixel data includes first chrominance pixel data and second chrominance pixel data, and
said pixel data types includes the first chrominance pixel data and the second chrominance pixel data.

6. The motion vector detecting device according to claim 4, wherein
said operational portion includes an operational portion assigning weights to said luminance pixel data heavier than said chrominance pixel data to perform said predetermined inter-pixel calculation when the type of said pixel data subjected to said predetermined inter-pixel calculation is said luminance pixel data.

7. The motion vector detecting device according to claim 6, wherein
said operational portion includes an operational portion further multiplying the result of said predetermined inter-pixel calculation by 1/K (K>1) when the type of said pixel data subjected to said predetermined inter-pixel calculation is said chrominance pixel data.

8. The motion vector detecting device according to claim 6, wherein
said operational portion includes an operational portion setting a predetermined number of low-order bit or bits to 0 in the result of said predetermined inter-pixel calculation when the type of said pixel data subjected to said predetermined inter-pixel calculation is said chrominance pixel data.

9. A motion vector detecting method comprising the steps of:
(a) providing template block data which defines pixel data in a template block and search window data which defines pixel data in a search window sized to contain said template block, wherein chrominance pixel data is contained in said template block data and said search window data according to a predetermined rule in a chrominance signal containing mode;
(b) calculating an evaluation value by performing a predetermined inter-pixel calculation between corresponding pieces of pixel data in said template block data and search window block data which is data in a search window block as a part of said search window, each time said search window block data is varied by using said search window data so that a displacement vector which shows the relative position of said search window block with respect to said template block is varied; and
(c) performing a comparison between said evaluation values corresponding to said displacement vectors and detecting a motion vector on the basis of the result of the comparison.

10. The motion vector detecting method according to claim 9, wherein
said chrominance signal containing mode includes a chrominance signal mode,
said step (a) includes a step of serving such that only said chrominance pixel data is contained in said template block data and said search window data according to said predetermined rule in said chrominance signal mode, said chrominance pixel data including first chrominance pixel data and second chrominance pixel data, and
said step (c) comprises a step of judging whether said evaluation values are valid or invalid on the basis of whether the chrominance pixel data types agree or disagree between the corresponding pieces of pixel data in said template block data and said search window block data on the basis of said displacement vectors in said chrominance signal mode, to perform said comparison between said evaluation values judged to be valid corresponding to said displacement vectors.

11. The motion vector detecting method according to claim 9, wherein
said chrominance signal containing mode includes a luminance and chrominance mix mode,
said step (a) includes a step of serving such that said luminance pixel data and said chrominance pixel data are contained in said template block data and said search window data according to said predetermined rule in said luminance and chrominance mix mode, and
said step (c) includes a step of judging whether said evaluation values are valid or invalid on the basis of whether the pixel data types agree or disagree between the corresponding pieces of pixel data in said template block data and said search window block data on the basis of said displacement vectors in said luminance and chrominance mix mode, to perform said comparison between said evaluation values judged to be valid corresponding to said displacement vectors.

12. The motion vector detecting method according to claim 11, wherein
said chrominance pixel data includes first chrominance pixel data and second chrominance pixel data, and
said pixel data types include the first chrominance pixel data and the second chrominance pixel data.

13. The motion vector detecting method according to claim 11, wherein
said step (b) includes a step of assigning weights to said luminance pixel data heavier than said chrominance pixel data to perform said predetermined inter-pixel calculation when the type of said pixel data subjected to said predetermined inter-pixel calculation is said luminance pixel data.

14. The motion vector detecting method according to claim 13, wherein
when the type of said pixel data subjected to said predetermined inter-pixel calculation is said chrominance pixel data, said step (b) includes the steps of,
(b-1) obtaining a result through said predetermined inter-pixel calculation, and
(b-2) further multiplying the result obtained in said step (b-1) by 1/K (K>1).

15. The motion vector detecting method according to claim 13, wherein
when the type of said pixel data subjected to said predetermined inter-pixel calculation is said chrominance pixel data, said step (b) includes the steps of,
(b-1) obtaining a result through said predetermined inter-pixel calculation, and
(b-2) setting a predetermined number of lower-order bit or bits to 0 in the result obtained in said step (b-1).
